(19) United States
(12) Patent Application Publication
(10) Pub. No.: US 2004/0177503 A1
(43) Pub. Date: Sep. 16, 2004

(54) Method for the production of a forged piston for an internal combustion engine

(75) Inventors: Karlheinz Bing, Remseck (DE); Gerhard Bucher, Ludwigsburg (DE)

Correspondence Address: WILLIAM COLLARD, COLLARD & ROE, P.C., 1077 NORTHERN BOULEVARD, ROSLYN, NY, 11576, US

(73) Assignee: Mahle GmbH

(21) Appl. No.: 10/734,806

(22) Filed: Dec. 12, 2003

(30) Foreign Application Priority Data
Mar. 14, 2003 (DE) 103 11 150.6

(51) Int. Cl. B21K 1/18; B23P 11/00

(52) U.S. Cl. 29/888.044

(57) ABSTRACT

A method for the production of a forged piston for an internal combustion engine, having a combustion depression provided on the piston head. The piston is formed from a first cylindrical unmachined part having at least one flat face made of oxidation-resistant steel and a second cylindrical unmachined part having at least one flat face made of hot-forgeable steel, with the same diameters (d), in each instance. The two unmachined parts are formed to produce a piston blank by means of forging, causing the combustion depression to be formed from oxidation-resistant steel. Subsequently the piston blank is finished via machining to produce a piston ready for installation in the internal combustion engine. Production of a piston having a reduced tendency to oxidize at the edge of the depression, and improved protection against wear caused by erosion, which is simple cost-effective, is achieved in that the unmachined parts are brought together at their faces and aligned with respect to their diameters, so that the faces form a minimal projection and parting. Subsequently, the parting is completely closed from the outside, by a weld seam that runs over the circumference.

### BACKGROUND OF THE INVENTION

1. Field of the Invention

The invention relates to a method for the production of a forged piston for an internal combustion engine, having a combustion depression provided on the piston head. The piston is formed from a first cylindrical unmachined part having at least one flat face made of oxidation-resistant steel and a second cylindrical unmachined part having at least one flat face made of hot-forgeable steel, with the same diameters. The two unmachined parts are formed via forging to produce a piston blank and subsequently finished via machining to produce a piston ready for installation in the internal combustion engine.

2. The Prior Art

In order to increase the performance of modern internal combustion engines, particularly diesel engines, the compression pressures and thereby the temperatures in the combustion space are constantly being increased. The result of this measure is that after running of the engine, oxidation is found on the steel piston having a combustion depression, or on steel piston heads, which oxidation particularly occurs at the edge of the depression, as a function of the operating temperature that was reached. This oxidation can lead to the formation of cracks and thereby to failure of the component. Likewise, material wear at the piston head, along the fuel injection tracks, is also critical, and makes protection against erosion wear necessary. Known solutions for improving this situation are, for example, coating the finished piston with an oxidation-resistant layer in the region of the edge of the depression, by means of plasma-spraying or application welding of more oxidation-resistant materials onto the pre-finished piston.

A method for the production of a piston or piston head for an internal combustion engine is described in PCT/DE02/02768, which solves the aforementioned problem in that a ring-shaped recess is worked into the face of an unmachined part consisting of steel, which recess is subsequently filled with an oxidation-resistant material, by means of welding. Subsequently, the unmachined part is forged to produce a piston, and afterwards finished to produce a piston ready for installation. The result achieved by the forging, i.e. forming process, is that the oxidation-resistant material comes to rest at the edge of the combustion depression of the piston. However, the relatively large number of process steps is a disadvantage, making the production of such a piston more expensive and ineffective.

A different solution is described in PCT Publication No. WO 02/06658 A1, in that a cylinder-shaped unmachined part made of chromium steel, i.e., an oxidation-resistant steel, is connected with a second cylinder-shaped unmachined part consisting of conventional steel (SE 4140), by means of friction welding, and subsequently formed into a piston by means of hot-forging. The piston is subsequently subjected to final finishing. A disadvantage of this process is that the two unmachined parts must be rigidly connected over a certain area, i.e. at their faces. The production method therefore requires a complicated pre-processing step for the production of a piston. In addition, because of the friction welding, a rather sizable degree of welding flash occurs on the circumference, which must be removed before the forging process by lathing or grinding, since the blank joined together in this way cannot be placed into the forging mold, and the welding flash material does not permit perfect forming with a resulting good metallic connection.

### SUMMARY OF THE INVENTION

It is therefore an object of the invention to provide a production method for a piston having a reduced tendency to oxidize at the edge of the depression, and improved protection against wear caused by erosion, in a simple and cost-effective manner.

This and other objects are achieved by a method for the production of a forged piston for an internal combustion engine, the piston having a combustion depression provided on the piston head, comprising forming the piston from a first cylindrical unmachined part having at least one flat face made of oxidation-resistant steel and a second cylindrical unmachined part having at least one flat face made of hot-forgeable steel, with the same diameters, in each instance, to produce a piston blank by forging. The unmachined parts are brought together at their faces and aligned with respect to their diameters, so that the faces form a minimal projection and parting. The parting is then closed completely from the outside, by producing a weld seam that runs over the circumference. The piston blank is then finished via machining to produce a piston ready for installation in the internal combustion engine.

The parting can be closed by welding at room temperature or in a heated state of the unmachined parts.

In a preferred embodiment, before forging, the unmachined parts, which have been welded together, are heated to a temperature of 1100° C. to 1300° C., and the unmachined parts are subsequently forged to produce a piston blank, in the heated state. Preferably, the heating process takes place inductively. The welding is preferably arc welding, laser welding, or electron beam welding.

With the production method according to the invention, full-area welding of the cylindrical unmachined parts with steel faces is no longer necessary, and the cutting process for removal of the welding flash, which is usually necessary, because of the friction welding process that is usually applied, becomes superfluous. The method for the production of a piston becomes more effective, since there is now a free choice of the welding process that can be used, and it becomes more economical in its implementation, because there is one processing step less.

This is because it has surprisingly been shown that a bubble-free as well as slag-free metallic bond is produced on the piston blank after forging, by closing only the parting that is formed by laying the faces of the two unmachined parts against one another, by means of welding from the outside over the entire circumference.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 is a schematic diagram of the sequence of the production method according to the invention, in Steps A to D; and

FIG. 2 is a schematic diagram of another variant of the production method according to the invention, in Step A.

### DETAILED DESCRIPTION OF THE PREFERRED EMBODIMENT

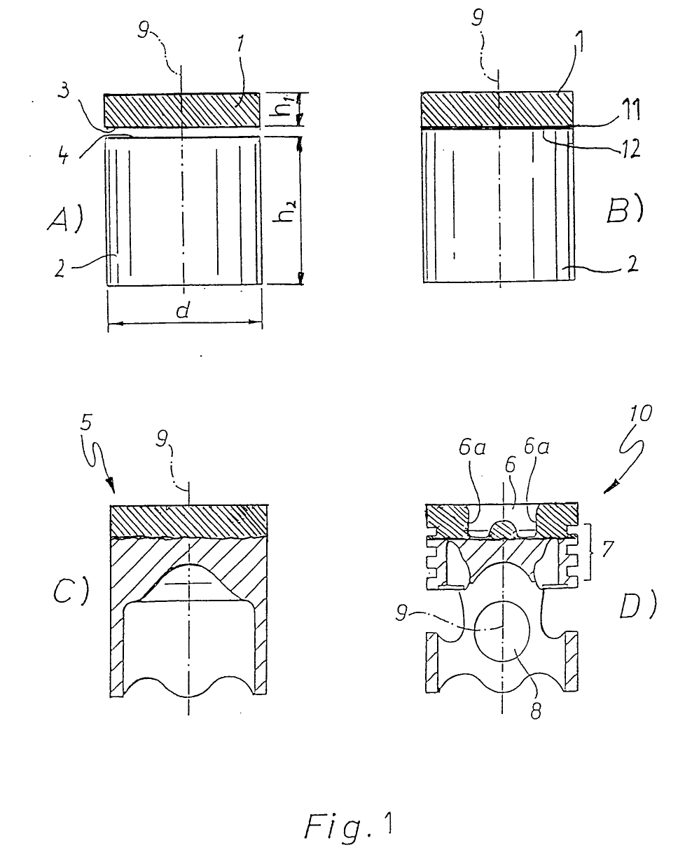

Referring now in detail to the drawings, FIG. 1 shows according to method step A), a cylindrical unmachined part made of oxidation-resistant steel, referred to as 1, having a flat face 3 formed at a right angle to its longitudinal axis 9, which face is produced by means of a lathing work step, for example. The unmachined part 1 consists of a material that has improved oxidation-resistance at temperatures above 500° C., such as the steel X45CrSi9, for example, or other suitable steels, or consists of materials based on nickel, cobalt, or titanium. Another cylindrical unmachined part made of hot-forgeable steel, referred to as 2, that preferably consists of a material 42CrMo4 or 38MnSiVS5, also has a flat face 4 formed at a right angle to its longitudinal axis 9. The two unmachined parts possess approximately the same diameter d, in each instance. Fundamentally, it can be determined by way of the height h₁ of the unmachined part 1 what piston regions of the piston 10, such as the depression edge region 6a, the complete combustion depression 6, or also parts of the ring part 7, are supposed to consist of oxidation-resistant material.

In another method step (not shown), the two unmachined parts can be subjected to a cleaning and degreasing process, using known means, in order to achieve grease-free, dust-free, and oxidation-free joining surfaces, in other words particularly faces 3 and 4. In general, a sufficient cleanliness quality is provided by the cutting process used to produce the join surfaces, i.e. faces.

In method step B), the unmachined parts 1 and 2 are brought together at their flat faces 3 and 4 by means of suitable holding means (not shown), and aligned with respect to their diameters d, so that faces 3 and 4 form a minimal projection and a minimally spaced parting 12. Parting 12 is completely closed over the circumference of the unmachined parts by means of a welding process, for example arc welding, laser welding, or electron beam welding, or other known connection methods. In order to avoid joining stresses, unmachined parts 1 and 2 can be heated before the welding process takes place, but this is not absolutely necessary for successfully implementing the method.

Forming of unmachined parts 1 and 2, which have been welded to one another on their circumference, to produce a piston blank 5, is carried out by means of known forging methods, as shown in method step C) of FIG. 1. For this purpose, unmachined parts 1 and 2, which have been welded to one another on their circumference, are subjected to inductive heating, for example, whereby the parts reach a temperature of 1100° C. to 1300° C. Inductive heating assures rapid heating of the unmachined parts that have been fixed in place, and thereby prevents oxidation of the faces in the parting. Producing a piston blank 5 by means of forging takes place immediately afterward, while still in the heated state.

The actual “welding together” of unmachined parts 1 and 2 takes place as a result of the forging process, by forming a join. The oxidation-resistant material, in other words unmachined part 1, is formed so that it comes to rest in the region of resulting depression edge 6a, i.e. the entire combustion depression 6. Local flow of the material as a result of the forging process, into the region of ring part 7, can also not be precluded. During subsequent cooling from the forging heat, the temperature is conducted in such a way that the two steel materials are present in the desired heat treatment state.

Subsequently, finishing of the piston blank to produce a piston 10 that can be used in an internal combustion engine, having the desired combustion depression 6, ring part 7, pin hub 8, etc., takes place by machining.

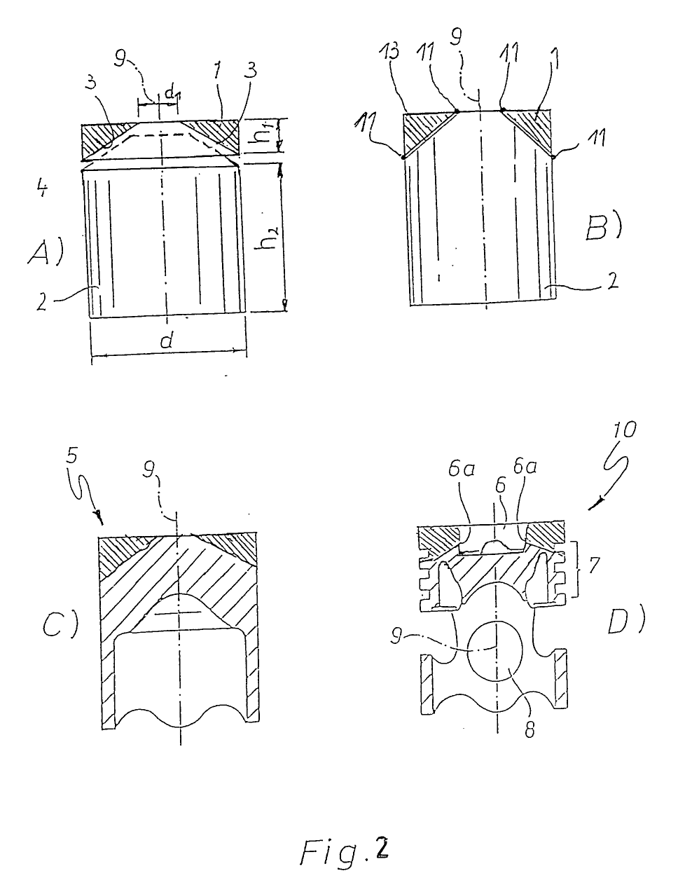

In another exemplary embodiment according to method step A) according to FIG. 2, unmachined part 1 is structured as a ring-shaped part, whose join surface, i.e. face 3 is structured to be conical or parallel to the plane of longitudinal axis 9 of the unmachined part, and against which face 4 of unmachined part 2, also structured to be conical or plane-parallel, comes to rest in such a way that the join surfaces, i.e. faces 3 and 4 form a minimal projection and a minimally spaced parting 12 relative to one another. Depending on the inside diameter d₁ and the height h₁ of ring-shaped unmachined part 1, it is determined whether the complete depression edge 6a, only the upper part of the depression edge that reached to the combustion space or, in addition, also part of the ring part 7 consists of the oxidation-resistant material.

Surprisingly, it has been shown that no differences in the structure are evident after the forging process according to method step C), whether the circumferential weld seam 11 is arranged on the circumference and/or on the cover surface 13 of unmachined parts 1 and 2, to close the parting. The only thing that is necessary is that the parting is closed once, in other words either on the circumference or on the cover surface, whereby the subsequent method steps are carried out analogous to the first exemplary embodiment.

The production method according to the invention can also be carried out using forged unmachined parts 1 and 2.

Accordingly, while only a few embodiments of the present invention have been shown and described, it is obvious that many changes and modifications may be made thereunto without departing from the spirit and scope of the invention.

Reference Symbols

Cylindrical unmachined part made of oxidation-resistant steel 1

Cylindrical unmachined part made of hot-forgeable steel 2

Flat face of the unmachined part 1 3

Flat face of the unmachined part 2 4

Piston blank 5

Combustion depression 6

Depression edge 6a

Ring part 7

Pin hub 8

Longitudinal axis of the unmachined parts 1, 2 9

Piston 10

Weld seam 11

Parting 12

Cover surface 13

Diameter of the unmachined parts 1, 2 d

Diameter of the unmachined part 1 in a second embodiment d₁

Height of the unmachined parts h_{1, 2}

What is claimed is:

1. A method for the production of a forged piston for an internal combustion engine, the piston having a combustion depression provided on the piston head, comprising the steps of:
forming the piston from a first cylindrical unmachined part having at least one flat face made of oxidation-resistant steel and a second cylindrical unmachined part having at least one flat face made of hot-forgeable steel, with the same diameters, to produce a piston blank by forging, said step of forming comprising:
bringing together the unmachined parts at their faces and aligning them with respect to their diameters, so that the faces form a minimal projection and parting; and
closing the parting completely from the outside, by producing a weld seam that runs over the circumference;
causing the combustion depression to be formed in the oxidation-resistant steel, and
finishing the piston blank via machining to produce a piston ready for installation in the internal combustion engine.

2. The method according to claim 1, wherein the parting is closed by welding at room temperature or in a heated state of the unmachined parts.

3. The method according to claim 2, wherein before forging, the unmachined parts, which have been welded together, are heated to a temperature of 1100° C. to 1300° C., and the unmachined parts subsequently forged to produce the piston blank, in the heated state.

4. The method according to claim 3, wherein the heating takes place inductively.

5. The method according to claim 2, wherein the welding is arc welding, laser welding, or electron beam welding.
